(19) United States
(12) Patent Application Publication
(10) Pub. No.: US 2005/0062698 A1
(43) Pub. Date: Mar. 24, 2005

(54) Liquid crystal display apparatus and driving method thereof

(75) Inventor: Hyung Ki Hong, Seoul (KR)

Correspondence Address: MORGAN LEWIS & BOCKIUS LLP, 1111 PENNSYLVANIA AVENUE NW, WASHINGTON, DC, 20004, US

(73) Assignee: LG.Philips LCD Co., Ltd.

(21) Appl. No.: 10/874,176

(22) Filed: Jun. 24, 2004

(30) Foreign Application Priority Data
Sep. 19, 2003 (KR) P2003-65233

(51) Int. Cl. G09G 3/36

(52) U.S. Cl. 345/87

(57) ABSTRACT

A liquid crystal display apparatus includes a liquid crystal display panel having at least first and second display regions, a plurality of lamps for irradiating light to the liquid crystal display panel, and a controller for controlling a brightness of each of the first and second display regions and for incorporating a first brightness adjustment to increase a brightness difference between the first and second display regions.

The present invention claims the benefit of Korean Patent Application No. 2003-65233 filed in Korea on Sep. 19, 2003, which is hereby incorporated by reference.

### BACKGROUND OF THE INVENTION

1. Field of the Invention

The present invention relates to a liquid crystal display apparatus and a driving method thereof, and more particularly, to a liquid crystal display device and a driving method thereof that control luminous brightness of each display location and have an improved display quality.

2. Discussion of the Related Art

Until recently, display devices generally employed cathode-ray tubes (CRTs). Presently, many efforts are being made to study and develop various types of flat panel displays, such as liquid crystal display (LCD) devices, plasma display panels (PDPs), field emission displays, and electro-luminescence displays (ELDs) as substitutions for CRTs in office automation devices, audio/video devices and the like because of their high resolution images, lightness, small thickness, compact size, and low voltage power supply requirements.

In general, an LCD device includes a liquid crystal display module and a driving circuitry for driving the liquid crystal display module. The liquid crystal display module includes a liquid crystal display panel having liquid crystal cells arranged in a matrix type between two glass substrates, and a back-light unit for irradiating light onto the liquid crystal display panel. In addition, optical sheets for directing the light from the back-light unit to the liquid crystal display panel in a vertical direction are arranged in the liquid crystal display module. The liquid crystal display panel, the back-light unit and the optical sheets are in an integral shape to prevent a light loss and to reduce damage caused by an external impact. Since the liquid crystal display module is not a spontaneous light-emitting display, the liquid crystal display module needs a light source as a back-light. There are two types of back-light units for liquid crystal display modules: an edge-type and a direct-below-type.

The edge-type back-light unit has a fluorescent lamp installed on an outside of a flat plate and a transparent light guide plate is used to guide light from the lamp to an entire surface of the liquid crystal panel. The direct-below-type back-light unit has a light source arranged in a rear surface of the liquid crystal display panel and directly radiates light to the entire surface of the liquid crystal display panel. As compared to the edge-type back-light unit, the direct-below-type back-light unit has an advantage in that a plurality of light sources can be used to improve a brightness and a light-emitting surface can be widened.

FIG. 1 is a perspective view of a liquid crystal display module according to the related art, and FIG. 2 is a sectional view of the liquid crystal display module along I-I′ in FIG. 1. In FIGS. 1 and 2, the liquid crystal display module 1 includes a main support 14, a back-light unit and a liquid crystal display panel 6 stacked at an inside of the main support 14, and a top case 2 for enclosing the edge of the liquid crystal display panel 6 and the side surface of the main support 14.

The liquid crystal display panel 6 includes an upper substrate 5 and a lower substrate 3. Liquid crystal materials are injected in a gap between the upper substrate 5 and the lower substrate 3 maintained by a spacer (not shown). The upper substrate 5 includes a color filter, a common electrode and a black matrix (not shown). Signal lines such as a data line and a gate line (not shown) are formed at the lower substrate 3, and a thin film transistor (TFT, not shown) is formed at an intersection between the data line and the gate line. The TFT switches a data signal to be transmitted from the data line in response to a scanning pulse from the gate line. A pixel electrode is formed at a pixel area between the data line and the gate line.

In addition, a pad area is formed in one side of the lower substrate 3 and is connected to each of the data line and the gate line. A tape carrier package (not shown) having a driver integrated circuit mounted thereon for applying a driving signal to the TFT is attached onto the pad area. This tape carrier package applies a data signal from the driver integrated circuit to the data line. Further, the tape carrier package applies the scanning signal to the gate line. Moreover, an upper polarizing sheet is attached onto the upper substrate 5 of the liquid crystal display panel 6 and a lower polarizing sheet is attached onto the rear side of the lower substrate 3 of the liquid crystal display panel 6.

The main support 14 is made from a mold material, and its inner lateral wall surface is molded into a stepped coverage face. The stepped coverage face has a securing part in which the back-light unit and the liquid display panel 6 are disposed.

The back-light unit includes a plurality of lamps 20 for irradiating light onto the liquid crystal display panel 6, a plurality of lamp holders 22 on which the lamps 20 are fixedly mounted, a diffuser 10 for diffusing incident light received from the lamps 20 to the liquid crystal display panel 6, a lamp housing 18 arranged on the rear surface of the lamps 20, and a plurality of optical sheets 8 stacked on the diffuser 10.

A cold cathode fluorescent lamp is used for the lamps 20. Each of the lamps 20 includes a glass tube having a cathode and an anode formed at the respective opposite ends of the glass tube. Inert gases are injected in the glass tube, and phosphorus is applied to an interior wall of the glass tube. The lamps 20 are grouped into N-number of lamps, “N” being a positive integer.

The diffuser 10 diffuses light irradiated from the lamps 20 toward a front surface of the liquid crystal display panel 6 in a uniform distribution. The diffuser 10 includes a transparent resin film whose both surfaces are coated with light-diffusion materials.

In addition, the lamp housing 18 includes a reflection sheet 12 and a bottom cover 16. The reflection sheet 12 is arranged on the rear surface of the lamp 20 and is made of a material reflecting the light having the same shape as the bottom cover 16. Further, the reflection sheet 12 has a bottom surface overlapping the bottom surface of the bottom cover 16 and an inclination surface correspondingly bent to the inclination surface of the bottom cover 16. The reflection sheet 12 is adhered to the bottom surface and the inclination surface of the bottom cover 16 by a double-sided adhesive tape (not shown). The reflection sheet 12 reflects the light from the rear surface and the side surface of the lamps 20 toward the liquid crystal display panel 6, to thereby improve the efficiency of the light irradiated on the liquid crystal display panel 6. Moreover, the bottom cover 16 has a bottom surface and an inclination surface extended from the bottom surface. That is, the bottom surface and the inclination surface of the bottom cover 16 are bent like a step.

The light exited from the diffuser 10 serves as the diffused light to make a viewing angle of the liquid display panel wider. The efficiency of the light incident to the liquid crystal display panel 6 is high when the incident light is perpendicular to the liquid crystal display panel 6. Accordingly, the optical sheets 8 are disposed on the diffuser 10 for making the light exiting from the diffuser 10 stand perpendicularly, to thereby improve the efficiency of the light. That is, light passes through the diffuser 10 and the optical sheets 8 before reaching to the liquid crystal display panel 6.

The top case 2 has a shape of a square band having a plane part and a side part bent perpendicular to each other. The top case 2 serves to enclose the edge of the liquid crystal display panel 6 and the main support 14.

FIG. 3 is a configuration of a liquid crystal display panel divided into a plurality of segment regions for driving according to the related art, and FIG. 4 is a configuration showing a problem generated at the time of driving the liquid crystal display panel according to the related art. The liquid crystal display module drives the liquid crystal display panel by dividing the panel into several segment regions corresponding to the number of the lamps 20, such that each of the segment regions is individually driven by the liquid crystal display module. In FIG. 3, the liquid crystal display panel is divided into five segment regions, SG1 . . . SG5 corresponding to five lamps, lamp1 . . . lamp5, respectively. If the second segment region SG2 is to be displayed brightly while the other segment regions are represented darkly, a lamp driving data having a higher brightness is applied to the second lamp lamp2 corresponding to the second segment region SG2.

However, in FIG. 4, the second segment region SG2 is further divided into a first region A that should be represented brightly and a second region B that should be represented darkly. Thus, by applying the lamp driving data having a higher brightness to the second lamp lamp2 the brightness of the second region B inevitably and undesirably increases. Thus, a display quality of the liquid crystal display apparatus deteriorates.

### SUMMARY OF THE INVENTION

Accordingly, the present invention is directed to a liquid crystal display apparatus and a driving method thereof that substantially obviate one or more of problems due to limitations and disadvantages of the related art.

An object of the present invention is to provide a liquid crystal display device and a driving method thereof that control luminous brightness of each display location, improve a display quality, and lower a lamp power consumption.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, the liquid crystal display apparatus includes a liquid crystal display panel having at least first and second display regions, a plurality of lamps for irradiating light to the liquid crystal display panel, and a controller for controlling a brightness of each of the first and second display regions and for incorporating a first brightness adjustment to increase a brightness difference between the first and second display regions.

In another aspect, the method of driving a liquid crystal display apparatus includes receiving pixel data for displaying an image on a liquid crystal display panel, detecting a brightness difference between a first display region and a second display region of the liquid crystal display panel, and incorporating a first brightness adjustment to increase the brightness difference between the first and second display regions.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 is a perspective view of a liquid crystal display module according to the related art;

FIG. 2 is a sectional view of the liquid crystal display module along I-I′ in FIG. 1;

FIG. 3 is a configuration of a liquid crystal display panel divided into a plurality of segment regions for driving according to the related art;

FIG. 4 is a configuration showing a problem generated at the time of driving the liquid crystal display panel according to the related art;

FIG. 5 is a configuration representing a liquid crystal display device according to an embodiment of the present invention;

FIG. 6 is a view of the liquid crystal display panel in FIG. 5;

FIG. 7 is a view of the data modulator in FIG. 5 according to another embodiment of the present invention;

FIG. 8 is a schematic view of a driven state of the display segment regions of the liquid crystal display panel in FIG. 5;

FIG. 9 is a graph representing brightness of the display segment regions of the liquid crystal display panel in FIG. 8;

FIGS. 10 and 11 are graphs representing adjustments in brightness for the display segment regions of the liquid crystal display panel in FIG. 8; and

FIG. 12 is a view showing the liquid crystal display panel in FIG. 5 according to another embodiment.

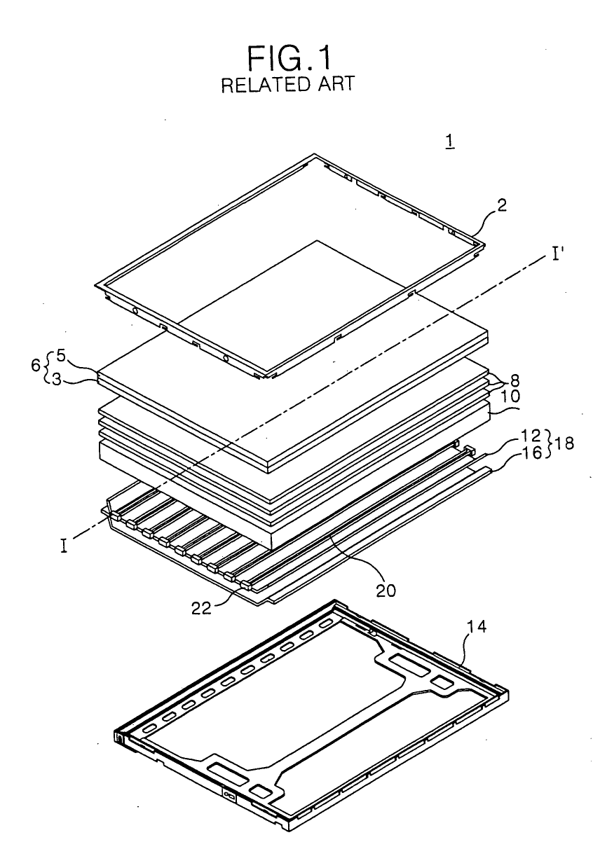

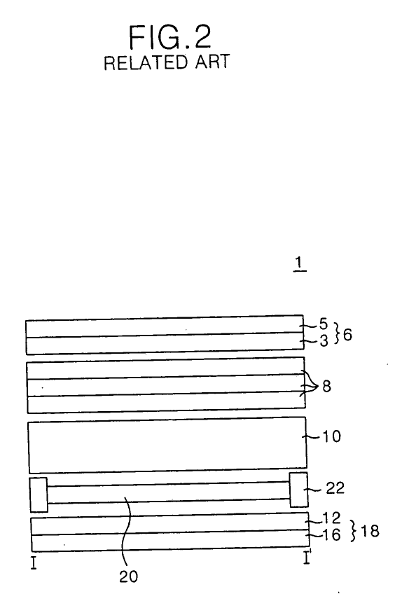

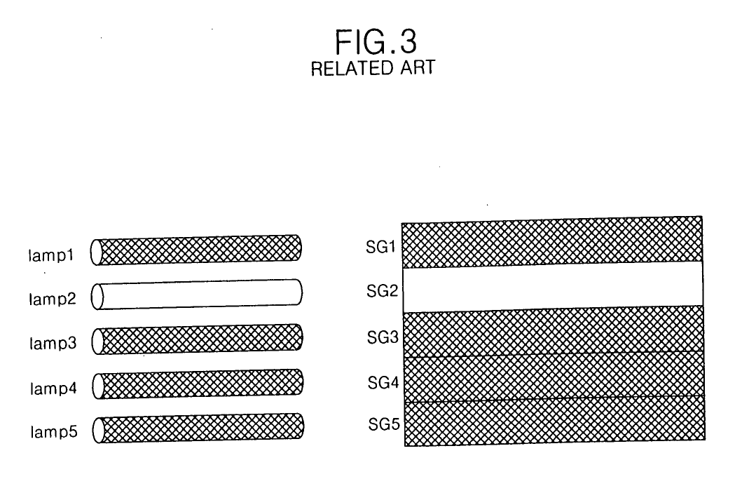

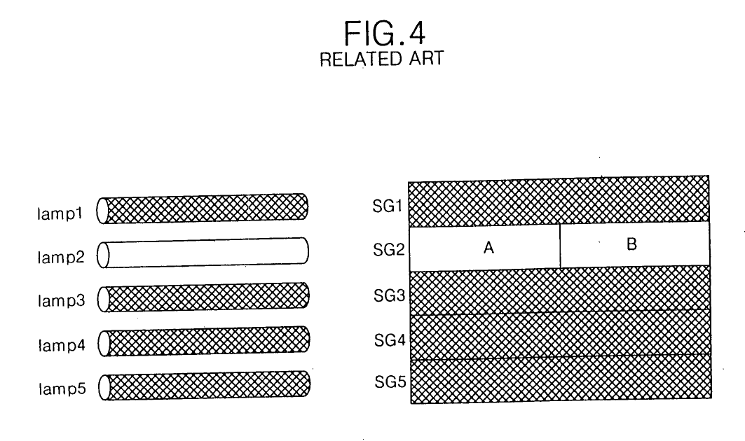

### DETAILED DESCRIPTION OF THE PREFERRED EMBODIMENTS

Reference will now be made in detail to the preferred embodiments, examples of which are illustrated in the accompanying drawings.

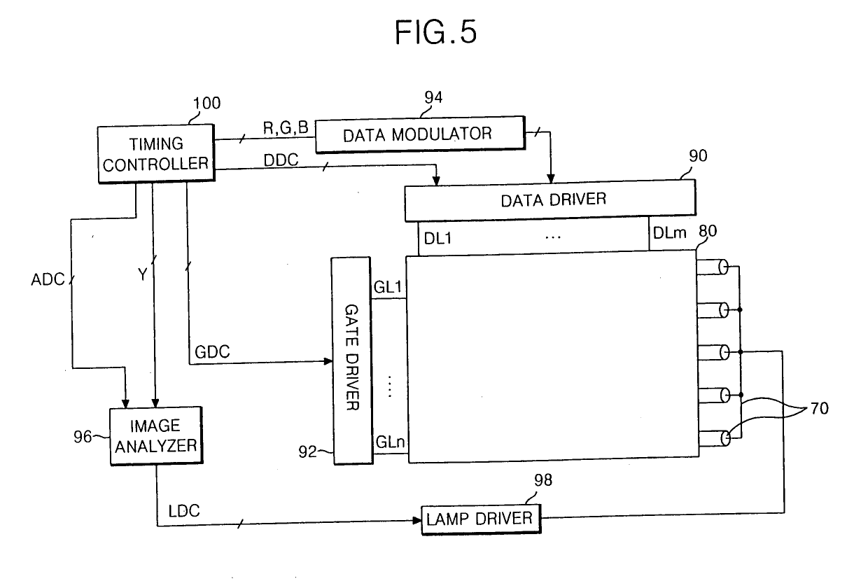

FIG. 5 is a configuration representing a liquid crystal display apparatus according to an embodiment of the present invention. In FIG. 5, the liquid crystal display apparatus may include a liquid crystal display panel 80, a data driver 90 for driving data lines DL1 . . . DLm of the liquid crystal display panel 80, a gate driver 92 for driving gate lines GL1 . . . GLn of the liquid crystal display panel 80, a data modulator 94 for modulating data supplied to the data driver 90, an image analyzer 96 for analyzing and correcting data supplied from an exterior, a lamp driver 98 for driving a plurality of lamps 70 depending on the data analyzed and corrected by the image analyzer 96, and a timing controller 100 for controlling the data driver 90, the gate driver 92, the data modulator 94, the image analyzer 96, and the lamp driver 98. The liquid crystal display panel 80 may be divided into a plurality of the display segment regions, which will be described in detail below.

In addition, the timing controller 100 may receive pixel data signals R, G, and B from an input source (not shown) and may apply the pixel data signals R, G, and B to the data driver 90 via the data modulator 94. The pixel data signals R, G, and B may include signals corresponding to each of the display segment regions of the liquid crystal display panel 80. Further, the timing controller 100 may received a brightness-information signal Y corresponding to the pixel data signals R, G, and B from the input source and may apply the brightness-information signal Y to the image analyzer 96.

The timing controller 100 also may receive a control signal from the input source for generating a gate control signal GDC, a data control signal DDC and an image analyzer control signal ADC for controlling the gate driver 92, the data driver 90 and the image analyzer 96, respectively. The gate control signal GDC may include a gate start pulse, a gate shift clock, and a gate output enable signal. For example, the gate start pulse may be applied to the gate lines GL1 . . . GLn to scan a full screen within one frame period. The data control signal DDC may include a source start pulse, a source shift clock signal, a source output enable signal, and a polarity control signal. Further, the image analyzer control signal ADC may be applied to synchronize the image analyzer 96 with the data control signal DDC being applied to the data driver 90.

The gate driver 92 may receive the gate control signal GDC from the timing controller 100. The gate driver 92 may then drive the gate lines GL1 . . . GLn by applying a gate high voltage to the gate lines GL1 . . . GLn sequentially in response to the gate control signal GDC, to thereby drive thin film transistors connected to the gate lines GL. . . . GLn. Further, the data driver 90 may receive the data control signal DDC from the timing controller 100. The data driver 90 may then apply the signals received from the data modulator 94 to the data lines DL1 . . . DLm for every horizontal period (H1, H2, . . . ) in response to the data control signal DDC. In addition, the data driver 90 may convert digital pixel data R, G, and B to analog pixel signals by using a gamma voltage from a gamma voltage generator (not shown).

Moreover, the image analyzer 96 may receive the brightness-information signal Y from the timing controller 100 and may calculate a luminous brightness of each display location based on the brightness-information signal Y. Then, the image analyzer 96 may generate and apply a lamp driving control signal LDC to the lamp driver 98. For example, when the liquid crystal display panel 80 is divided into a plurality of display segment regions, and when i^{th} segment region, “i” being a natural number, is bright and segment regions adjacent to the i^{th} segment region are dark, the image analyzer 96 may reduce luminous brightness of these adjacent segment regions for displaying the i^{th} segment region more brightly. Accordingly, the image analyzer 96 may generate the lamp driving control signal LDC reflecting such a brightness adjustment in these adjacent segment regions. At the same time, the timing controller 100 may apply the image analyzer control signal ADC to the image analyzer 96 for synchronizing the image analyzer 96 with the data driver 90.

In addition, the lamps 70 may be fixedly mounted on a lamp holder (not shown) and may include cold cathode fluorescent lamps to irradiate light to the liquid crystal display panel 80. For example, each of the lamps 70 may include a glass tube having a cathode and an anode formed at opposite ends of the glass tube, respectively. Inert gases may be injected into the glass tube, and phosphorus may be applied on an interior wall of the glass tube. The lamps 70 may be grouped into N-number of lamps, “N” being a positive integer. Further, the lamps 70 may be arranged to correspond to each of the display segment regions of the liquid crystal display panel 80, such that the lamp driver 98 may drive the lamps 70 based on the lamp driving control signal LDC to reflect brightness adjustment to the display segment regions made by the image analyzer 96.

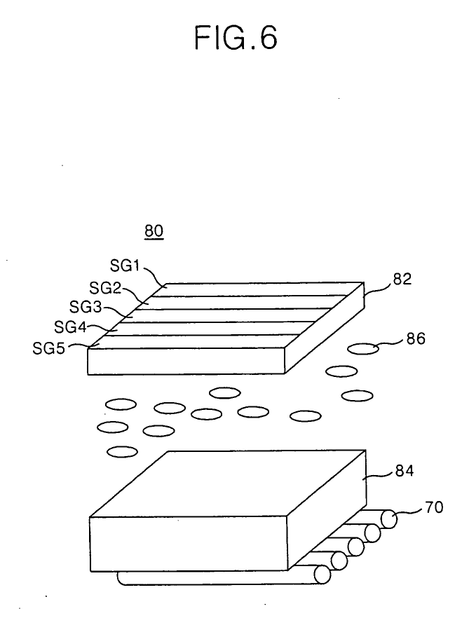

FIG. 6 is a view showing the liquid crystal display panel in FIG. 5. In FIG. 6, the liquid crystal display panel 80 may include an upper substrate 82 and a lower substrate 84. The liquid crystal display panel 80 may include a spacer (not shown) for maintaining a predetermined gap between the upper substrate 82 and the lower substrates 84, and liquid crystal materials may be injected in the gap to form a liquid crystal layer 86 between the upper substrate 82 and the lower substrate 84.

In addition, a color filter, a common electrode and a black matrix (not shown) may be formed on the upper substrate 82, and signal lines such as a data line and a gate line (not shown) may be formed on the lower substrate 84. A thin film transistor (not shown) also may be formed at an intersection between the data line and the gate line for switching a data signal to the data line in response to a scanning pulse from the gate line. Further, a pixel electrode (not shown) may be formed at a pixel area between the data line and the gate line, and a pad area (not shown) may be formed on one side of the lower substrate 84 where the data line and the gate line extend into. A tape carrier package (not shown) having a driver integrated circuit for applying a driving signal to the TFT may be mounted on the pad area. For example, the tape carrier package may apply the data signal from the driver integrated circuit to the data line and may supply the scanning signal to the gate line.

The liquid crystal layer 86 may adjust transmittance of light incident via the lower substrate 84 from the lamps 70 in response to a voltage applied to the pixel electrode and the common electrode. In particular, the liquid crystal display panel 80 may be divided into a plurality of the display segment regions, SG1 . . . SG5.

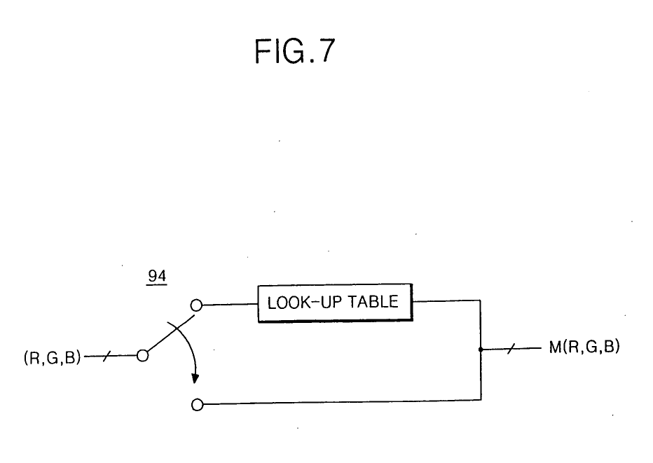

FIG. 7 is a view showing the data modulator in FIG. 5. In FIG. 7, the data modulator 94 may receive the pixel data signals R, G, and B from the timing controller 100 (shown in FIG. 5). The data modulator 94 may have a switching means for bypassing the pixel data signals R, G, and B without a modulation to the data driver 90. Alternatively, the data modulator 94 may modulate the pixel data signals R, G, and B to generate modulated pixel data signals M(R,G,B). The data modulator 94 may include a ROM having a look-up table in which a predetermined modulation data may be stored to modulate the pixel data signals R, G, and B. Then, the modulated pixel data signals M(R,G,B) may be applied to the data driver 90. In addition, a low voltage may be applied to the modulated pixel data signals M(R,G,B) for a particular display segment region, which should be represented darkly, to thereby lower light transmittance of the particular display segment region.

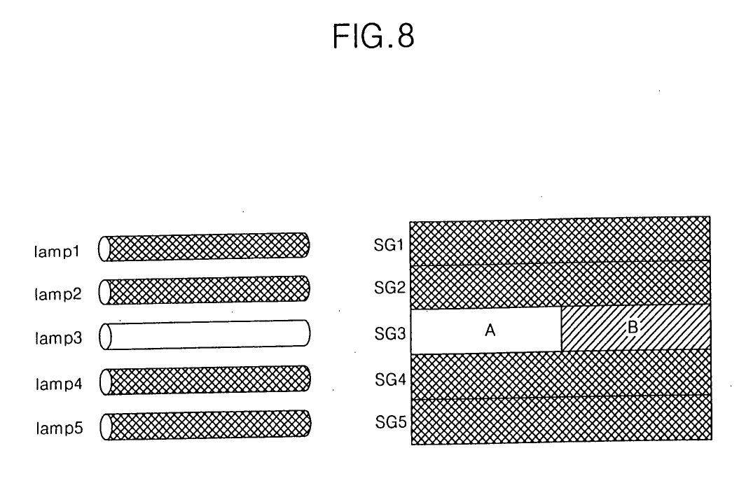

FIG. 8 is a schematic view of a driven state of the display segment regions of the liquid crystal display panel in FIG. 5. As shown in FIG. 8, a third display segment region SG3 may be driven with a higher luminous brightness than other display segment regions. For example, the pixel data signals R, G, and B may be received by the timing controller 100 (shown in FIG. 5) from the input source (not shown). The brightness-information signal Y corresponding to the pixel data signals R, G, and B also may be received by the image analyzer 96 (shown in FIG. 5) from the input source via the timing controller 100. Then, a luminous brightness for each of the display segment regions may be calculated by the image analyzer 96 (shown in FIG. 5) based on the bright information Y and may be applied to the lamp driver 98 for driving the lamps 70.

In particular, to drive the third display segment region SG3 brighter than the other display segment regions, a third lamp lamp3 associated with the third display segment region SG3 may receive a lamp driving data having a higher brightness than lamps associated with the other display segment regions. Thus, the image analyzer 96 (shown in FIG. 5) may adjust lamp driving data corresponding to a second lamp lamp2 and a fourth lamp lamp4 adjacent to the third lamp lamp3 to a lower brightness as they are originally applied.

In addition, if the third display segment region SG3 is divided into first and second regions A and B, and if the first region A is to be represented brightly, the data originally supplied to the second region B also may be modulated by the data modulator 94 to an adjusted data having a transmittance lower than that of the data originally supplied. The adjusted data may then be supplied to the data driver 90. As a result, only the first region A in the third display segment region SG3 may be represented brightly, while other display segment regions and the second region B in the third display segment region may be represented darkly.

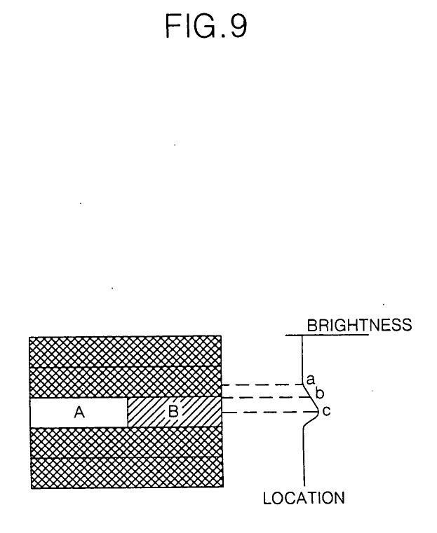

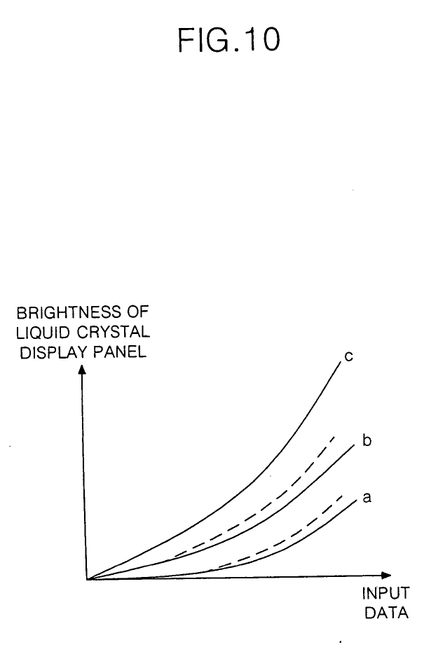

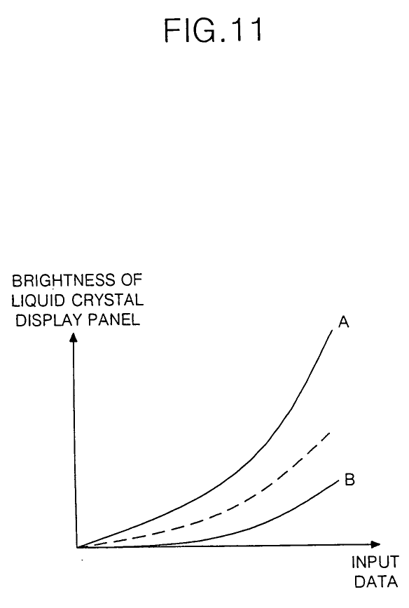

FIG. 9 is a graph representing brightness of the display segment regions of the liquid crystal display panel in FIG. 8, and FIGS. 10 and 11 are graphs representing an adjustments in brightness for the display segment regions of the liquid crystal display panel in FIG. 8. As shown in FIG. 9, to drive the first region A of the third display segment region SG3 brightest among the display segment regions shown in FIG. 8, the lamp driving data may reflect a brightness at a location ‘c’ be highest comparing to brightness at locations ‘b’ and ‘a,’ while a brightness at the location ‘b’ be higher than the location ‘a.’

In FIG. 10, an X-axis represents an input data supplied to the liquid crystal panel 80 and a Y-axis represents the brightness achieved in the liquid crystal display panel 80. Accordingly, the image analyzer 96 may analyze the pixel data supplied thereto and may apply an original lamp driving data to the third lamp lamp3 associated with the third display segment region SG3. In addition, the image analyzer 96 may apply an adjusted lamp driving data having a lower brightness than that of the original lamp driving data (shown as dotted lines) to the lamps associated with the display segment regions adjacent to the third display segment region SG3. As a result, a brightness as denoted by a solid line in FIG. 10 may be obtained. Since the lamp driving data having the lower brightness is applied to the lamps associated with the display segment regions adjacent to the third display segment region SG3, a power consumption can be reduced. Although FIG. 10 illustrates decreasing brightness for the display segment regions adjacent to the third display segment region SG3, it is possible to change the relative brightness display between the display segment regions, for example, by increasing the brightness for the third display segment region SG3 while maintain the original brightness for these display segment regions or by increasing the brightness for the third display segment region SG3 while decreasing the brightness of the other display segment regions.

As the adjusted lamp driving data are applied, both the first and second regions A and B of the third display segment region SG3 may be represented brightly. As shown in FIG. 11, the brightness of the second region B of the third display segment region SG3 may be reduced from the dotted line to the solid line by adjusting the pixel data applied to the second region B. In particular, the pixel data applied to the second region B may be modulated by the data modulator 94. The data modulator 94 may lower a voltage value of the pixel data corresponding to the second region B, and a transmittance of liquid crystal materials corresponding to the second region B may then be lowered than that of the first region A. As a result, a brightness as indicated by the solid line in FIG. 11 can be obtained and a display quality of the liquid crystal display apparatus is improved.

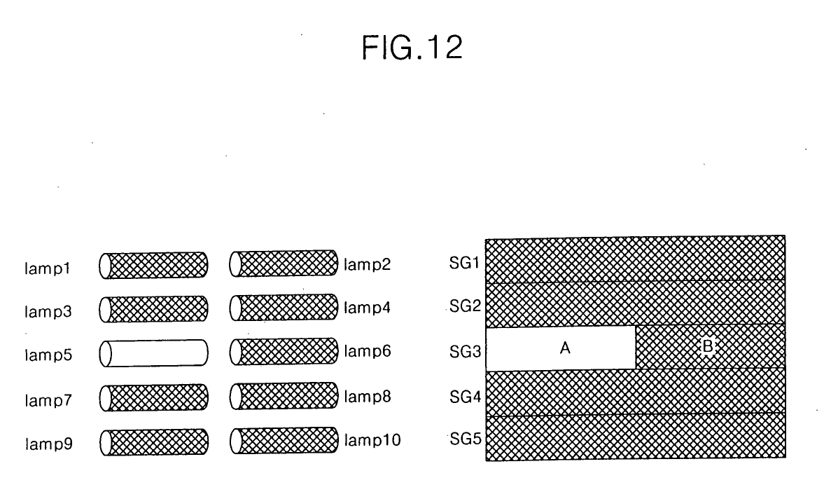

FIG. 12 is a view showing the liquid crystal display panel in FIG. 5 according to another embodiment. In FIG. 12, each of the lamps corresponding to one display segment region may be divided into a set of at least two or more sub-lamps and each set may be installed in one of the display segment region. For example, each of the lamps may be partitioned into at least a set of two or more portions in a width direction of the liquid crystal display panel 80. Thus, a brightness in each location of each display segment region associated with each sub-lamp in the set may be individually controlled and adjusted.

As described above, in a liquid crystal display apparatus and a driving method thereof according to an embodiment of the present invention, if it is desired to make bright a particular segment region among a plurality of segment regions partitioned on a liquid crystal display panel, pixel data supplied to segment regions adjacent to the particular region are corrected to have a lower brightness. Accordingly, the liquid crystal display apparatus and the method of driving the same can improve a brightness. In addition, the liquid crystal display apparatus and the method of driving the same change a transmittance of a liquid crystal material at a particular segment region on the liquid crystal display panel, to thereby improve a brightness at only the particular region.

It will be apparent to those skilled in the art that various modifications and variations can be made in the above-discussed liquid crystal display apparatus and the driving method thereof without departing from the spirit or scope of the invention. Thus, it is intended that the present invention cover the modifications and variations of this invention provided they come within the scope of the appended claims and their equivalents.

1. A liquid crystal display apparatus, comprising:
a liquid crystal display panel having at least first and second display regions;
a plurality of lamps for irradiating light to the liquid crystal display panel; and
a controller for controlling a brightness of each of the first and second display regions and for incorporating a first brightness adjustment to increase a brightness difference between the first and second display regions.

2. The liquid crystal display apparatus of claim 1, wherein the first brightness adjustment includes decreasing brightness of the first display region and maintaining brightness of the second display region.

3. The liquid crystal display apparatus of claim 2, wherein a lamp driving data for the lamps corresponding to the first display region is lowered by the controller to increase the brightness difference between the first and second display regions.

4. The liquid crystal display apparatus of claim 1, further comprising a data modulator for modulating data signals for data lines of the liquid crystal display panel and for incorporating a second brightness adjustment to further increase the brightness difference.

5. The liquid crystal display apparatus of claim 4, wherein the data modulator incorporates the second brightness adjustment by altering light transmittance of at least a portion of one of the first and second display regions.

6. The liquid crystal display apparatus of claim 4,
wherein the first brightness adjustment includes decreasing brightness of the first display region and maintaining brightness of the second display region by lowering a lamp driving data for the lamps corresponding to the first display region, and
wherein the second brightness adjustment includes lowering light transmittance of at least a portion of the first display region.

7. The liquid crystal display apparatus of claim 1, wherein each of the lamps is partitioned in a width direction of the liquid crystal display panel.

8. The liquid crystal display apparatus of claim 1, wherein the controller receives and analyzes a brightness information data, and independently controls each of the lamps in accordance with the analyzed data.

9. A method of driving a liquid crystal display apparatus, comprising:
receiving pixel data for displaying an image on a liquid crystal display panel;
detecting a brightness difference between a first display region and a second display region of the liquid crystal display panel; and
incorporating a first brightness adjustment to increase the brightness difference between the first and second display regions.

10. The method of claim 9, wherein the step of incorporating the first brightness adjustment includes decreasing brightness of the first display region and maintaining brightness of the second display region.

11. The method of claim 10, wherein the step of decreasing the brightness of the first display region includes lowering a lamp driving data for lamps corresponding to the first display region.

12. The method of claim 9, further comprising:
modulating data signals for data lines of the liquid crystal display panel; and
incorporating a second brightness adjustment to further increase the brightness difference.

13. The method of claim 12, wherein the step of incorporating the second brightness adjustment includes altering light transmittance of at least a portion of one of the first and second display regions.

14. The method of claim 12,
wherein the step of incorporating the first brightness adjustment includes decreasing brightness of the first display region and maintaining brightness of the second display region by lowering a lamp driving data for lamps corresponding to the first display region, and
wherein the step of incorporating the second brightness adjustment includes lowering light transmittance of at least a portion of the first display region.

15. The method of claim 9, further comprising partitioning a plurality of lamps corresponding to the first and second display regions in a width direction of the liquid crystal display panel.

16. The method of claim 9, further comprising:
receiving and analyzing a brightness information data; and
independently controls a plurality of lamps corresponding to the first and second display regions in accordance with the analyzed data.
